(19) United States
(12) Patent Application Publication
(10) Pub. No.: US 2018/0369734 A1
(43) Pub. Date: Dec. 27, 2018

(54) QUIET GEN

(71) Applicant: Luke Nnaemeka Aneke, Springfield Gardens, NY (US)

(72) Inventor: Luke Nnaemeka Aneke, Springfield Gardens, NY (US)

(21) Appl. No.: 15/634,308

(22) Filed: Jun. 27, 2017

(51) Int. Cl. B01D 46/42; B01D 46/00; G10K 11/16

(52) U.S. Cl. CPC B01D 46/4236; G10K 11/161; B01D 46/003

(57) ABSTRACT

A silencing accessory or specially designed muffler to be attached to the exhaust of a portable generator, which is specially designed to reduce or eradicate excessive noise, as well as filter emissions. The present invention comprises a replaceable filter to provide a product that solves the problems of noise and air pollution created by these necessary units

### BACKGROUND OF THE INVENTION

### 1. Field of the Invention

The present invention relates, in general, to the field of muffler devises and more specifically to a silencing accessory or specially designed muffler to be attached to the exhaust of a portable generator, which is specifically designed to reduce or eradicate excessive noise, as well as filter emissions. The present invention comprises a replaceable filter to provide a product that solves the problem of noise and air pollution created by these necessary units.

### 2. Description of Related Art

Many consumers recognize the importance of having a backup power source in the event of an emergency situation. Whether one's electricity is lost for a few hours during a thunderstorm or is out for several days due to natural disasters or other emergency circumstances, this loss of electric power can be detrimental to one's comfort, safety and health. From perishables spoiling in a refrigerator and frozen foods thawing, to a lack of an available light source during the evening hours, the loss of electricity can be especially dangerous during stifling days of summer or frigid winter months, as many consumers, especially seniors or those who suffer various medical conditions, depend on air conditioning and heating units in order to maintain comfort, physical health and medication preservation.

Being without electricity can also render one technologically cut off from the rest of the world, a problem that can be especially challenging for those who reside in rural areas. To prevent these problems, many turn to portable generators to ensure there is no interruption of electric power. The need for generators has steadily risen in the past decade as widespread power outages accompanying overtaxes grids and a steady increase in devastating storms every year as a result of climate change and global warming, have been the norm rather than the exception. However, as necessary as generators are to both households and businesses, their use can present environmental challenges such as noise and air pollution.

Particularly, the noise that accompany generator use can often reach decibel levels of 100 and above. In areas where more than one generator are operating, such as in a disaster area where there can easily be a cacophony of generator noise pervading the entire community, the noise can lead to health problems among individuals exposed to it for more than brief periods of time. In addition to noise pollution, generators can cause air pollution. Generators emit particulate matter containing completely and incompletely burnt hydrocarbons and oxides of nitrogen, which add to air pollution. If the generator is not in good condition, it can also emit unburnt hydrocarbons which are even worse for the environment.

Various attempts have been made to solve the problems found in muffler device art. Among these are found in: U.S. Pat. No. 3,675,398 to Lawrence P. Giarrizzo; U.S. Pat. No. 3,863,733 to Raudman Jr Charles J.; and U.S. Pat. No. 2,667,940 to Gallihugh Gordon W. This prior art is representative of silencing and/or filtering mufflers.

None of the above Inventions and patents, taken either singly or in combination, is seen to describe the invention as claimed. Thus, a need exists for a reliable Quiet Gen, a silencing accessory or specifically designed muffler to be attached to the exhaust of a portable generator, which is especially designed to reduce or eradicate excessive noise, as well as filter emissions. The present invention comprises a replaceable filter to provide a product that solves the problem of noise and air pollution created by these necessary units to avoid the above-mentioned problems.

### BRIEF SUMMARY OF ME INVENTION

In view of the foregoing disadvantages inherent in the known muffler device art, the present invention provides a novel Quiet Gen. The general purpose of the present invention, which will be described subsequently in greater detail, is to a silencing accessory or specially designed muffler to be attached to the exhaust of a portable generator, which is specially designed to reduce or eradicate excessive noise, as well as filter emissions. The present invention comprises a replaceable filter to provide a product that solves the problems of noise and air pollution created by these necessary units. The features of the invention which are believed to be novel arc particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Quiet Gen, constructed and operative according to the teachings of the present invention.

FIG. 1 shows a perspective view illustrating a Quiet Gen according to an embodiment of the present invention.

FIG. 2 is a perspective view illustrating the Quiet Gen according to an embodiment of the present invention.

The various embodiments of the present invention will hereinafter be described in conjunction with the appended drawings.

### DETAILED DESCRIPTION

As discussed above, embodiments of the present invention relate to a muffler device and more particularly to a Quiet Gen, a silencing accessory or specially designed muffler to be attached to the exhaust of a portable generator, which is specially designed to reduce or eradicate excessive noise, as well as filter emissions. The present invention comprises a replaceable filter to provide a product that solves the problems of noise and air pollution created by these necessary units

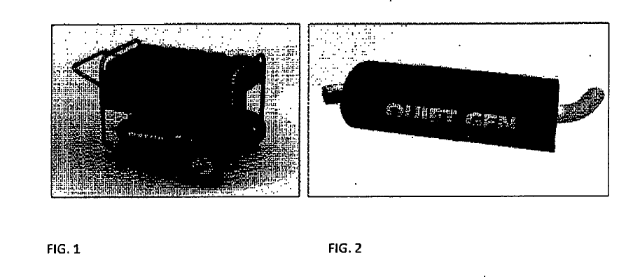

Referring now to the drawings FIGS. 1-2, the Quiet Gen comprising a novel product offering consumers a practical solution to the aforementioned challenges. As the name implies, the Quiet Gen comprises a specially designed universal accessory for portable generators that is specially designed to reduce or eradicate excessive noise, as well as filter emissions.

Retrofitted to existing Units or integrated at point of manufacture of new generators, the Quiet Gen would be an elongated device attachable to the generator's exhaust port. Made of metal material with fireproof baffels, this product would measure approximately eighteen inches (18″) in length and five inches (5″) in diameter, with the proximal end tapering to better fit over the generator's exhaust. In addition to its internal muffler, the Quiet Gen would boast a replaceable filter inside the unit, which could be produced in the form of a coalescing filter. In the area of compressed air purification, coalescing filters are used to separate liquid water and oil from compressed air using a coalescing effect. These filters additionally remove particles.

The most commonly used media in this case is Borosilicate micro-fiber. To facilitate attachment to an existing generator, the Quiet Gen would offer an adjustable, universal collar with a receiving end that is placed directly over the generator's exhaust pipe, and tightened in a manner similar to a hose clamp. Once the Quiet Gen is in place, it is able to immediately begin muffling the device's excessive noise while, at the same time, capturing hydrocarbon emissions before they can be released into the air.

The Quiet Gen would improve portable generator usage by significantly reducing or eradicating the extreme noise common to these needed power providers. With a Quiet Gen, users need not worry that they will be angering neighbors during extended blackouts while also shielding themselves and those around them from the possible health risks and environmental damage due to emissions. Additionally, both households and businesses that find themselves needing to use generators would be able to remain in compliance with local noise ordinances, which often require generators to be turned off should they exceed a predetermined noise level. With the high possibility of more and more power outages to come thanks to weakened power grids and rapid climate change, a product such as the Quiet Gen would prove quite beneficial during these challenging times. The Quiet Gen would also be appreciated by outdoor enthusiasts, such as campers, hunters, and fishermen, during extreme temperatures. The Quiet Gen is cost-effective to produce in the embodiments, as shown in FIGS. 1-2.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A silencing and/or filtering muffler essentially as described herein.
